(19) United States
(12) Patent Application Publication
(10) Pub. No.: US 2024/0329295 A1
(43) Pub. Date: Oct. 3, 2024

(54) PLASTIC OPTICAL FIBER, OPTICAL CORD, AND ACTIVE OPTICAL CABLE

(71) Applicant: NITTO DENKO CORPORATION, Osaka (JP)

(72) Inventors: Takashi Shimizu, Ibaraki-shi (JP); Toru Moriya, Ibaraki-shi (JP); Kazuya Takayama, Ibaraki-shi (JP); Hiroshi Ohmura, Ibaraki-shi (JP)

(73) Assignee: NITTO DENKO CORPORATION, Osaka (JP)

(21) Appl. No.: 18/616,399

(22) Filed: Mar. 26, 2024

(30) Foreign Application Priority Data
Mar. 28, 2023 (JP) 2023-052387
Nov. 20, 2023 (JP) 2023-196995

(51) Int. Cl. G02B 6/028

(52) U.S. Cl. CPC G02B 6/0281

(57) ABSTRACT

A plastic optical fiber of the present disclosure includes: a core including a first region having a refractive index decreasing in a direction from a center of the core toward an outer edge of the core; and a trench disposed on an outer circumference of the core. When a refractive index difference between a refractive index n1 at the outer edge of the core and a refractive index n2 of the trench is defined as Δn and a thickness of the trench is defined as d (μm), a value of Δn×d is 0.010 or more and 0.06 or less.

### BACKGROUND OF THE INVENTION

### 1. Field of the Invention

The present invention relates to a plastic optical fiber, an optical cord, and an active optical cable.

### 2. Description of Related Art

An optical fiber includes: a core located in a central portion of the optical fiber and configured to transmit light; and a region called a cladding or a trench, the region being located on an outer circumference of the core and configured to keep light within the core.

Optical fibers are categorized into plastic optical fibers (hereinafter referred to as “POFs”) whose core is made of a resin material and glass optical fibers (hereinafter referred to as “GOFs”) whose core is made of a glass material. POFs are superior to GOFs in pliability and have better bending resistance (i.e., flexibility) and processability than GOFs. Hence, POFs are commonly used for short-distance use in a terminal section (e.g., in-home wiring) of an optical fiber transmission network.

POFs include step-index (SI) POFs and grated-index (GI) POFs. An SI-POF is a POF in which the refractive index of the core is uniform. A GI-POF is a POF having a refractive-index distribution in which the refractive index of the core decreases from the center of the core toward the outer edge of the core. For an SI-POF, the propagation time varies according to the path (mode) of light; therefore, a signal pulse is broadened, and the SI-POF has a degraded band. On the other hand, a GI-POF has an improved band and is capable of high-speed communication because the refractive-index distribution thereof dramatically narrows a propagation time difference.

A GI-POF is provided with a trench on the outer circumference of the core so that a bending loss will be smaller and light from a wider angular range can be received (i.e., the numerical aperture (NA) can be larger), the trench being optically designed to have a refractive index that is lower than the refractive index at the outer edge of the core.

For example, JP 2012-159836 A discloses an optical fiber including a trench, the optical fiber having a small bending loss, the optical fiber having a wide bandwidth.

### SUMMARY OF THE INVENTION

However, a trench provided for the purpose of, for example, making a bending loss smaller degrades the band by reflecting light incident on the trench. Degradation of the band by reflecting light in the trench is more significant in the case of a POF extending over a shorter distance and is less influential in the case of a POF extending over a longer distance. The reason is that while light is guided through a POF, constituents, such as scattered light and light incident on the POF at a greater angle than the numerical aperture (NA) of the POF, of the light are lost, the constituents contributing to degrading the band. In other words, the longer the distance over which a POF extends is, the more such band-degrading constituents of the light decreases.

As described above, POFs are commonly used for a short-distance use, and are likely to be affected by band-degrading constituents of light in a shorter distance. However, in the field of optical fibers, no techniques focusing on improvement of the band of a POF, particularly a POF provided with a trench for making a bending loss smaller, in a short distance have been proposed.

The present disclosure aims to provide a POF including a trench for decreasing the bending loss, the POF having an improved band in a short distance. The present disclosure also aims to provide an optical cord and an active optical cable each including the POF having an improved band in a short distance.

A POF according to a first aspect of the present disclosure includes:
a core including a first region having a refractive index decreasing in a direction from a center of the core toward an outer edge of the core; and
a trench disposed on an outer circumference of the core, wherein
when a refractive index difference between a refractive index n1 at the outer edge of the core and a refractive index n2 of the trench is defined as Δn and a thickness of the trench is defined as d (μm), a value of Δn×d is 0.010 or more and 0.06 or less.

An optical cord according to a second aspect of the present disclosure includes the POF according to the first aspect of the present disclosure.

An active optical cable according to a third aspect of the present disclosure includes:
the optical cord according to the second aspect of the present disclosure; and
an optoelectronic hybrid module.

The present disclosure can provide a POF having an improved band in a short distance. The present disclosure can also provide an optical cord and an active optical cable each including the POF having an improved band in a short distance.

### BRIEF DESCRIPTION OF THE DRAWINGS

FIG. 1 is a schematic diagram showing an example of a cross-sectional structure of a POF according to a first embodiment of the present disclosure.

FIG. 2 is a graph showing a profile of a refractive index of the POF according to the first embodiment of the present disclosure.

FIG. 3 is a schematic diagram showing an example of a cross-sectional structure of a first modification of the POF according to the first embodiment of the present disclosure.

FIG. 4 is a graph showing a profile of a refractive index of the first modification of the POF of the first embodiment of the present disclosure.

FIG. 5 is a schematic diagram showing an example of a cross-sectional structure of a second modification of the POF of the first embodiment of the present disclosure.

FIG. 6 is a schematic cross-sectional view showing an example of a manufacturing apparatus that can be used to manufacture the POF according to the first embodiment of the present disclosure.

FIG. 7 is a schematic diagram showing an example of an optical cord including the POF according to the first embodiment of the present disclosure.

FIG. 8 is a schematic diagram showing an example of an active optical cable including the POF according to the first embodiment of the present disclosure.

FIG. 9 is a schematic diagram showing a measurement system for measuring bending losses of POFs of Examples and Comparative Examples.

### DETAILED DESCRIPTION OF THE INVENTION

### Definition

An optical loss of a plastic optical fiber (POF) bent into a U-shape at a bending radius of R mm herein means an optical loss determined by the following procedure.
(a) Connecting a light source to an input side of a POF (length: 5 m) and an optical power meter to a light receiving side of the POF.
(b) Winding the POF 10 times around a 12.5 mm-diameter cylinder at a point one meter from the input side of the POF to remove a cladding mode.
(c) Measuring light using the POF in a straight state.
(d) Setting a central portion (a portion 2.5 m from both sides) of the POF in a plate with a U-shaped groove having a bending radius R to bend the POF.
(e) Confirming an amount of change in insertion loss attributable to the change from a straight state to a bending state to determine an optical loss.

### First Embodiment of the Present Disclosure

A POF according to a first embodiment of the present disclosure will be described.

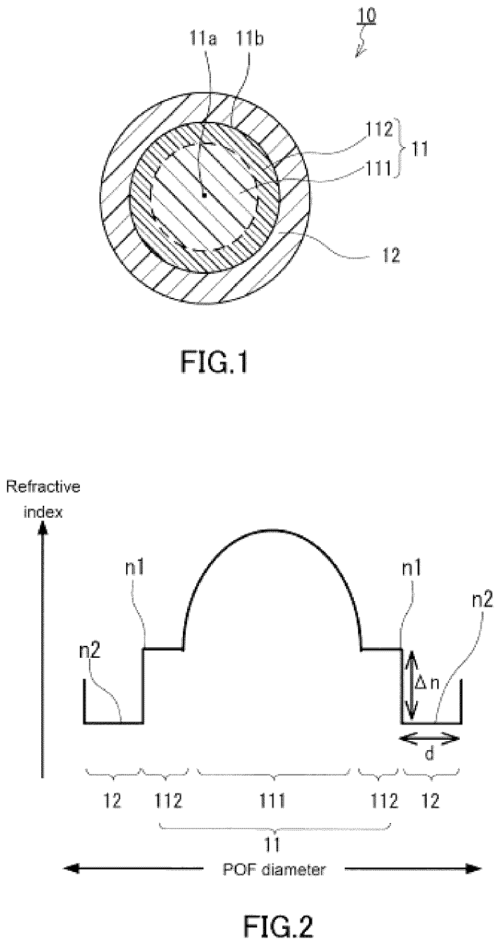

FIG. 1 is a schematic diagram showing an example of a cross-sectional structure of the POF according to the first embodiment of the present disclosure. FIG. 2 is a graph showing a profile of a refractive index of the POF according to the first embodiment of the present disclosure.

A POF 10 according to the present embodiment includes: a core 11; and a trench 12 disposed on an outer circumference of the core 11. The core 11 includes a first region 111 having a refractive index decreasing in a direction from a center 11a toward an outer edge 11b. When a refractive index difference between a refractive index n1 at the outer edge 11b of the core 11 and a refractive index n2 of the trench 12 is defined as Δn and a thickness of the trench 12 is defined as d (μm), a value of Δn×d is 0.010 or more and 0.06 or less. In the POF 10 of the present embodiment, the core 11 may further include a second region 112 including the outer edge 11b and having a refractive index being constant at the refractive index n1. It should be noted that the refractive indices of the core 11 and the trench 12 are refractive indices for light with a wavelength (e.g., 850 nm) equal to that of light propagating within the core 11.

In the POF 10 according to the present embodiment, the first region 111 of the core 11 has a refractive-index distribution. Therefore, the POF 10 according to the present embodiment is a GI-POI. Specifically speaking, as shown in FIG. 2, a center of the first region 111 of the core 11 has the maximum refractive index, and the refractive index of the first region 111 gradually decreases toward the second region 112. Additionally, when the core 11 includes the second region 112, the refractive index in the second region 112 is constant. Moreover, the refractive index in the trench 12 may also be constant, for example. Saying that “the refractive index is constant” in each region means that a difference between the maximum refractive index and the minimum refractive index in each region is 0.003 or less. As shown in FIG. 2, a POF diameter refers to the diameter of a POF including the core 11 and the trench 12. It should be noted that when the refractive index n2 of the trench 12 varies in the trench 12, a refractive index of an inner edge of the trench 12 is used as a value of the refractive index n2, which is used to determine the refractive index difference Δn, of the trench 12.

In the POF 10 of the present embodiment, the product of Δn×d, namely a product of the refractive index difference Δn between the refractive index n1 at the outer edge 11b of the core 11 and the refractive index n2 of the trench 12 provided to keep light within the core 11 and the thickness d (μm) of the trench 12, satisfies 0.010 or more and 0.06 or less. When light propagating through the core 11 is incident on the trench 12, the POF 10 configured as above leaks the light incident on the trench 12 to the outside or scatters the light so that reflection of the light by the trench 12 and consequent propagation of the reflected light through the core 11 can be reduced. Hence, the POF 10 according to the present embodiment can reduce degradation of the band due to reflection of light incident on the trench 12. Hence, the POF 10 according to the present embodiment can have a small bending loss and can achieve an improved band in a short distance.

The POF for a short distance use has a length of, for example, 30 m or shorter, desirably 10 m or shorter, and more desirably 5 m or shorter. The POF for a short distance use has a length of, for example, 1 m or longer.

It should be noted that the band of the POF 10 according to the present embodiment is a value measured by a pulse method which is one of methods according to IEC 60793-1-41, and the excitation condition under which the measurement is performed is overfilled launch using overfill light. The term “overfill light” refers to incident light whose numerical aperture (NA) is greater than the numerical aperture (NA) of a POF to be measured and whose beam diameter is greater than a core diameter of the POF to be measured.

The term “core diameter” of a POF herein refers to an outer diameter of the core of the POF. The outer diameter of the core refers to a diameter of 5% light intensity, the diameter being measured by a near field pattern method (hereinafter referred to as “NFP method”), which is one of methods according to IEC 60793-1-20 and IEC 60793-2-40 subcategory A4h, using light with a wavelength of 850 nm. The diameter of 5% light intensity refers to a diameter of an approximate circle defined by points where the light intensity is 5% of a peak value of the light intensity. Additionally, a point where the luminance is 100% means a point where the luminance is maximum in the core. Incidentally, the outer edge 11b of the core 11 can be determined by the same method as for the core diameter, namely, by the NFP method.

When the core 11 includes the second region 112 too, the first region 111 and the second region 112 of the core 11 can be determined by the NFP method as for the above measurement of the core diameter of the POF. The refractive index in the core 11 can be determined by a plane distribution of light intensity of output light, the plane distribution being obtained by measurement by the NFP method. Therefore, using the plane distribution of the light intensity of output light, it is possible to distinguish the first region 111 having a refractive-index distribution from the second region 112 having a constant refractive index and determine the outer diameter of each region. Specifically, the first region 111 and the second region 112 can be distinguished by an inflection point determined by differentiation of the plane distribution of the light intensity of the output light. The thickness of the second region 112 can be found by determining the outer diameters of the regions.

An outer diameter of the trench 12 can be determined, for example, by microscopic observation or using a SEM. The core diameter and the outer diameter of the trench 12 can be determined by the NFP method. The thickness d (μm) of the trench 12 can be found by determining the core diameter and the outer diameter of the trench 12.

The refractive index n1 at the outer edge 11b of the core 11 and the refractive index n2 of the trench 12 can be determined by the following method. When the second region 112 is provided, the refractive index n1 of the second region 112 can also be determined by this method.

First, the materials of the core and the trench are each molded by hot-pressing to obtain sheets having a thickness of about 100 μm. The sheets obtained were set in a prism coupler to determine their refractive indices. Subsequently, an angular aperture was measured by a far field pattern method, and a difference between refractive indices of the core and the trench was determined. Finally, the refractive index n1 at the outer edge 11b of the core 11 and the refractive index n2 of the trench 12 are calculated according to 2.4 of a paper (Mitsuhiro Tachibana, “Method for measuring refractive-index distribution of optical fiber”, OYO BUTURI, vol. 48, no. 8).

To further improve the band, the value of Δn×d is preferably 0.015 or more and 0.06 or less, more preferably 0.02 or more and 0.06 or less, and even more preferably 0.035 or more and 0.06 or less.

To make it possible to improve the band, reduce the bending loss, and receive light from a wider angular range, the thickness d (μm) of the trench 12 is preferably 2 μm or more and 10 μm or less. To further improve the band by making it easier for light incident on the trench 12 to leak to the outside, the thickness d (μm) of the trench 12 is preferably 2 μm or more and 8 μm or less.

To improve the heat resistance as well as the band, the value of Δn×d may be, for example, 0.010 or more and less than 0.030. When the value of Δn×d is 0.010 or more and less than 0.030, heat-caused degradation of the band of the POF 10 is reduced. Consequently, the POF 10 of the present embodiment has a further improved heat resistance. As described above, when the value of Δn×d is 0.010 or more and less than 0.030, the POF 10 of the present embodiment has an improved heat resistance as well as an improved band in a short distance.

To further improve the band and even the heat resistance, the value of Δn×d is preferably 0.012 or more and less than 0.030, more preferably 0.012 or more and 0.026 or less, and even more preferably 0.013 or more and 0.026 or less.

To further improve the band and even the heat resistance, the thickness d (μm) of the trench 12 is preferably 2 μm or more and 5 μm or less, and more preferably 2 μm or more and 4.5 μm or less.

When the POF 10 of the present embodiment has an excellent heat resistance as described above, for example, when optical power is used to evaluate a band value of the POF 10 of the present embodiment having been held at 85° C. for 1000 hours, the optical power can be more than −0.65 dB at a frequency of 4 GHZ.

To further improve the band by making it easier for light incident on the trench 12 to leak to the outside, the refractive index difference Δn between the refractive index n1 and the refractive index n2 is preferably 0.012 or less, more preferably 0.011 or less, even more preferably 0.010 or less, and particularly preferably 0.009 or less. To keep light within the core 11, reduce the bending loss, and receive light from a wider angular range, the refractive index difference Δn is preferably 0.003 or more.

A first optical loss of the POF 10 according to the present embodiment bent into a U shape at a bending radius of 1.5 mm is, for example, preferably 3.0 dB or less, and more preferably 2.0 dB or less. Since the POF 10 according to the present embodiment is a POF including the core 11 made of a resin material, the POF 10 according to the present embodiment has a small bending loss compared to GOFs. Since the POF 10 according to the present embodiment further includes the trench 12, the POF 10 according to the present embodiment can reduce the bending loss to the above range. This configuration allows the POF 10 according to the present embodiment to further reduce the bending loss to the above range and achieve an improved band in a short distance. The first optical loss is, for example, 0.5 dB or more. Hence, the first optical loss may be 0.5 dB or more and 3.0 dB or less, or 0.5 dB or more and 2.0 dB or less. The method for measuring the first optical loss being a bending loss will be described below in EXAMPLES.

Moreover, a second optical loss of the POF 10 according to the present embodiment bent into a U shape at a bending radius of 2.5 mm is, for example, preferably 1.0 dB or less. This configuration allows the POF 10 according to the present embodiment to further reduce the bending loss to the above range and achieve an improved band in a short distance. The second optical loss is, for example, 0.01 dB or more. Hence, the second optical loss is, for example, 0.01 dB or more and 1.0 dB or less. The method for measuring the second optical loss being a bending loss will be described below in EXAMPLES.

The POF 10 according to the present embodiment can achieve a large numerical aperture (NA) by virtue of the presence of the trench 12. Therefore, the POF 10 according to the present embodiment can receive light from a wider angular range. The POF 10 according to the present embodiment has, for example, a numerical aperture (NA) of 0.15 or more and 0.24 or less.

The constituents of the POF 10 of the present embodiment will be hereinafter described in more details.

### (Core 11)

The core 11 is a region configured to transmit light. As described above, the core 11 includes the first region 111 having a refractive-index distribution. The outer edge 11b of the core 11 has the refractive index n1. The core 11 may further include the second region 112 including the outer edge 11b and having a refractive index being constant at the above refractive index n1. The refractive index n1 at the outer edge 11b of the core 11 is higher than the refractive index n2 of the trench 12. Because of this configuration, light incident on the core 11 is kept within the core 11 by the trench 12 and propagates in the POF 10.

The core 11 includes a first resin. The core 11 may include the first resin as its main component. Here, saying that the core 11 includes the first resin as its main component means that the first resin is a component whose content is highest in the core 11 on a mass basis. The first resin content in the core 11 may be 75 mass % or more, 80 mass % or more, or 85 mass % or more.

The core 11 may further include an additive in addition to the first resin. The additive is, for example, a refractive index modifier. That is, the core 11 may be made of a resin composition including the first resin and an additive such as the refractive index modifier. The refractive index modifier can be, for example, a known refractive index modifier included in the material of the core 11 of the POF 10. The material of the core 11 may include an additive other than the refractive index modifier.

The first region 111 of the core 11 has the refractive-index distribution in which the refractive index decreases in the direction from the center 11a of the core 11 toward the outer edge 11b thereof. Such a refractive-index distribution can be formed, for example, by adding a refractive index modifier to the first resin and diffusing the refractive index modifier in the first resin (for example, by thermal diffusion). The second region 112 of the core 11 can be formed by adjusting, for example, conditions (e.g., a diffusion temperature and a diffusion time) for diffusing the refractive index modifier in the first resin (for example, by thermal diffusion) and, in the case of manufacturing the POF 10 according to the present embodiment by melt spinning, an amount of the core material discharged, the second region 112 having the constant refractive index n1.

The first resin included in the core 11 is not limited to a particular one as long as the first resin is a resin having high transparency. Examples of the first resin include fluorine-containing resins, acrylic resins such as methyl methacrylate, styrene resins, and carbonate resins.

The first resin included in the core 11 may be at least one selected from the group consisting of a fully-fluorinated resin, a partially-fluorinated resin, a partially-chlorinated resin, and a partially-deuterated resin. A partially-fluorinated resin, a partially-chlorinated resin, and a partially-deuterated resin herein each refer to a resin which is based on a resin known as a core material of POFs in this technical field and in which one or some of hydrogen atoms in a C—H bond are fluorinated, chlorinated, or deuterated. A fully-fluorinated resin herein refers to a resin which is based on a resin known as a core material of POFs in this technical field and in which every hydrogen atom in a C—H bond is fluorinated. Examples of the resins known as core materials in this technical field include, as described above, acrylic resins such as methyl methacrylate, styrene resins, and carbonate resins. A polymer having an aliphatic ring structure, such as a polymer having a dioxolane structure, may be used.

The first resin is desirably at least one selected from the group consisting of a fully-fluorinated resin and a partially-fluorinated resin. That is, the first resin is desirably a fluorine-containing resin.

The first resin of the core 11 is preferably a fluorine-containing resin including a fluorine-containing polymer. Hereinafter, the fluorine-containing resin included in the core 11 is referred to as a first fluorine-containing resin, and the fluorine-containing polymer included in the first fluorine-containing resin is referred to as a first fluorine-containing polymer.

It is preferred that the first fluorine-containing polymer included in the first fluorine-containing resin be substantially free of a hydrogen atom from the viewpoint of reducing light absorption attributable to stretching energy of a C—H bond. It is particularly preferred that every hydrogen atom bonded to a carbon atom be substituted by a fluorine atom. That is, it is preferred that the first fluorine-containing polymer be substantially free of a hydrogen atom and be fully-fluorinated. Herein, saying that the fluorine-containing polymer is substantially free of a hydrogen atom means that the hydrogen atom content in the fluorine-containing polymer is 1 mol % or less.

The first fluorine-containing polymer preferably has a fluorine-containing aliphatic ring structure. The fluorine-containing aliphatic ring structure may be included in a main chain of the fluorine-containing polymer, or may be included in a side chain of the first fluorine-containing polymer. The first fluorine-containing polymer has, for example, a structural unit (A) represented by the following structural formula (1).

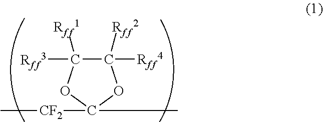

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. “Perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

In the case where R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by the following formulae (A1) to (A8).

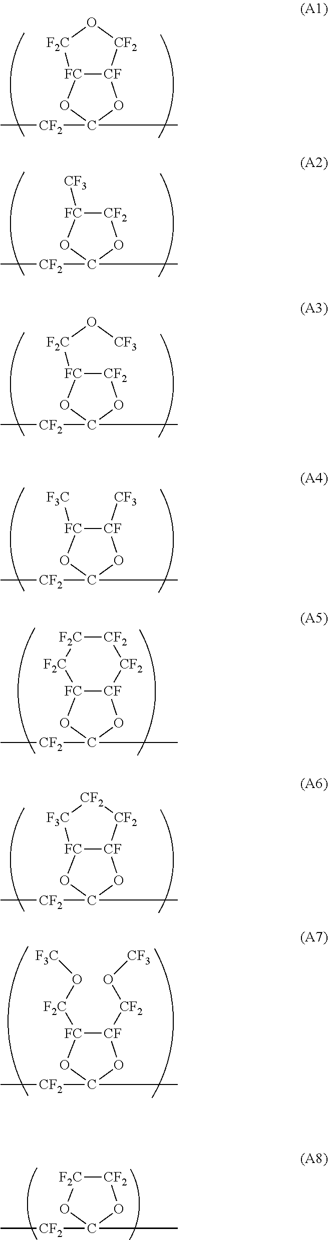

Among the structural units represented by the above formulae (A1) to (A8), the structural unit (A) is preferably the structural unit (A2), i.e., a structural unit represented by the following formula (2).

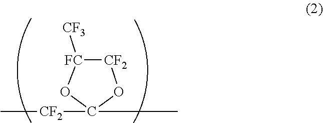

The first fluorine-containing polymer may include one or more structural units (A). In the first fluorine-containing polymer, the amount of the structural unit (A) is preferably 20 mol % or more and more preferably 40 mol % or more of a total amount of all structural units. When the structural unit (A) accounts for 20 mol % or more of the first fluorine-containing polymer, the first fluorine-containing polymer tends to have much higher thermal resistance. When the structural unit (A) accounts for 40 mol % or more of the first fluorine-containing polymer, the first fluorine-containing polymer tends to have much higher transparency and much higher mechanical strength in addition to high thermal resistance. In the first fluorine-containing polymer, the amount of the structural unit (A) is preferably 95 mol % or less and more preferably 70 mol % or less of the total amount of all structural units.

The structural unit (A) is derived from, for example, a compound represented by the following formula (3). In the formula (3), R_{ff}¹ to R_{ff}⁴ are as described in the formula (1). It should be noted that the compound represented by the formula (3) can be obtained, for example, by an already-known manufacturing method such as a manufacturing method disclosed in JP 2007-504125 A.

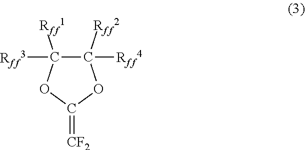

Specific examples of the compound represented by the above formula (3) include compounds represented by the following formulae (M1) to (M8).

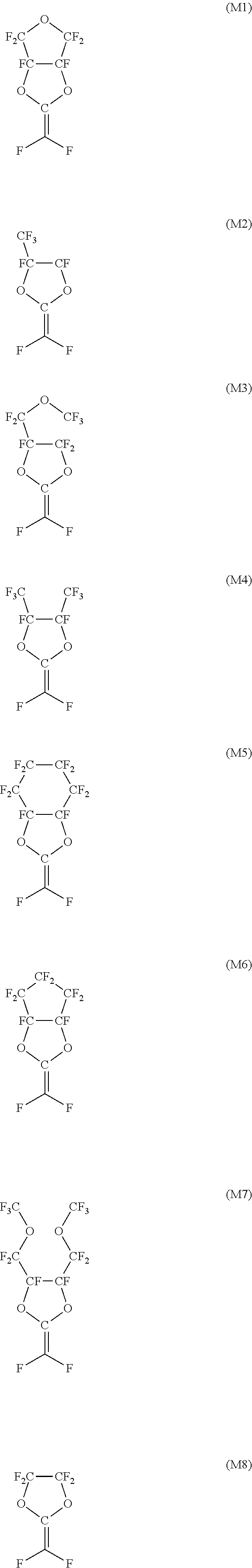

The fluorine-containing polymer may further include an additional structural unit other than the structural unit (A). Examples of the additional structural unit include the following structural units (B) to (D).

The structural unit (B) is represented by the following formula (4).

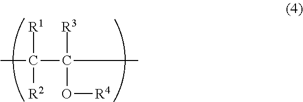

In the formula (4), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The fluorine-containing polymer may include one or more structural units (B). In the fluorine-containing polymer, the amount of the structural unit (B) is preferably 5 to 10 mol % of the total amount of all structural units. The amount of the structural unit (B) may be 9 mol % or less or 8 mol % or less.

The structural unit (B) is derived from, for example, a compound represented by the following formula (5). In the formula (5), R¹ to R⁴ are as described for the formula (4). The compound represented by the formula (5) is a fluorine-containing vinyl ether such as perfluorovinyl ether.

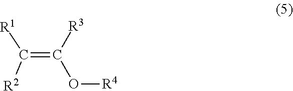

The structural unit (C) is represented by the following formula (6).

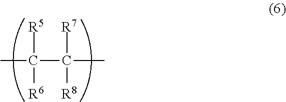

In the formula (6), R⁵ to R⁸ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The fluorine-containing polymer may include one or more structural units (C). In the fluorine-containing polymer, the amount of the structural unit (C) is preferably 5 to 10 mol % of the total amount of all structural units. The amount of the structural unit (C) may be 9 mol % or less or 8 mol % or less.

The structural unit (C) is derived from, for example, a compound represented by the following formula (7). In the formula (7), R⁵ to R⁸ are as described for the formula (6). The compound represented by the formula (7) is a fluorine-containing olefin such as tetrafluoroethylene or chlorotrifluoroethylene.

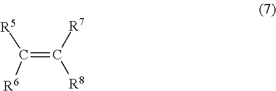

The structural unit (D) is represented by the following formula (8).

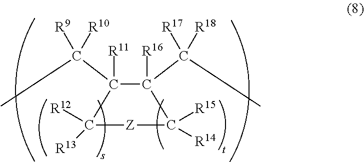

In the formula (8), Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom. Symbols s and t are each independently 0 to 5, and s+t is an integer of 1 to 6 (when Z is —OC(R¹⁹R²⁰)O—, s+t may be 0).

The structural unit (D) is preferably represented by the following formula (9). The structural unit represented by the following formula (9) is a structural unit represented by the above formula (8), where Z is an oxygen atom, s is 0, and t is 2.

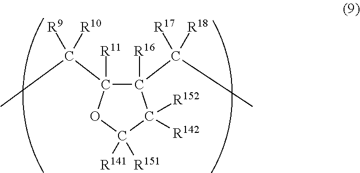

In the formula (9), R¹⁴¹, R¹⁴², R¹⁵¹, and R¹⁵² are each independently a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom.

The fluorine-containing polymer may include one or more structural units (D). In the fluorine-containing polymer, the amount of the structural unit (D) is preferably 30 to 67 mol % of the total amount of all structural units. The amount of the structural unit (D) is, for example, 35 mol % or more, and may be 60 mol % or less or 55 mol % or less.

The structural unit (D) is, for example, derived from a compound represented by the following formula (10). In the formula (10), Z, R⁹ to R¹⁸, s, and t are as described for the formula (8). The compound represented by the formula (10) is a cyclopolymerizable fluorine-containing compound having two or more polymerizable double bonds.

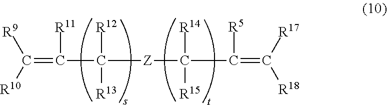

The structural unit (D) is preferably derived from a compound represented by the following formula (11). In the formula (11), R¹⁴¹, R¹⁴², R¹⁵¹, and R¹⁵² are as described for the formula (9).

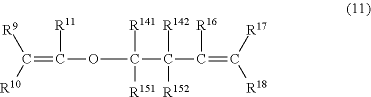

Specific examples of the compound represented by the formula (10) or the formula (11) include the following compounds.
CF₂═CFOCF₂CF═CF₂
CF₂═CFOCF(CF₃)CF═CF₂
CF₂═CFOCF₂CF₂CF═CF₂
CF₂═CFOCF₂CF(CF₃)CF═CF₂
CF₂═CFOCF(CF₃)CF₂CF═CF₂
CF₂═CFOCFClCF₂CF═CF₂
CF₂═CFOCCl₂CF₂CF═CF₂
CF₂═CFOCF₂OCF═CF₂
CF₂═CFOC(CF₃)₂OCF═CF₂
CF₂═CFOCF₂CF(OCF₃)CF═CF₂
CF₂═CFCF₂CF═CF₂
CF₂═CFCF₂CF₂CF═CF₂
CF₂═CFCF₂OCF₂CF═CF₂
CF₂═CFOCF₂CFClCF═CF₂
CF₂═CFOCF₂CF₂CCl═CF₂
CF₂═CFOCF₂CF₂CF═CFCl
CF₂═CFOCF₂CF(CF₃)CCl═CF₂
CF₂═CFOCF₂OCF═CF₂
CF₂═CFOCCl₂OCF═CF₂
CF₂═CClOCF₂OCCl═CF₂

The first fluorine-containing polymer may further include an additional structural unit other than the structural units (A) to (D). However, the fluorine-containing polymer is preferably substantially free of an additional structural unit other than the structural units (A) to (D). Saying that the fluorine-containing polymer is substantially free of an additional structural unit other than the structural units (A) to (D) means that the sum of the amounts of the structural units (A) to (D) is 95 mol % or more and preferably 98 mol % or more of the total amount of all structural units in the fluorine-containing polymer.

The method for polymerizing the first fluorine-containing polymer is not limited to a particular one, and a common polymerization method such as radical polymerization can be used. A polymerization initiator for the polymerization of the fluorine-containing polymer may be a fully-fluorinated compound.

The first fluorine-containing polymer is included in the first fluorine-containing resin used as the first resin. A first glass transition temperature Tg₁ of the first resin is, for example, but not particularly limited to, 100° C. to 140° C., and may be 105° C. or higher or 120° C. or higher. Herein, “Tg” refers to a midpoint glass transition temperature (T_{mg}) determined according to JIS K 7121:1987.

The refractive index of the first region 111 of the core 11 preferably has a refractive-index distribution where, for example, g in the following mathematical expression (1) satisfies 1.9≤g≤2.1. Incidentally, Δ in the mathematical expression (1) is represented by the following mathematical expression (2).

$$n 1 ( r ) = {{n}_{A} [ 1 - 2 {Δ ( r / a )}^{g} ]}^{1 / 2} \qquad Mathematical expression ( 1 )$$

$$Δ = ( {{n}_{A}}^{2} - {{n}_{B}}^{2} ) / 2 n {A}^{2} \qquad Mathematical expression ( 2 )$$

In the mathematical expressions (1) and (2), r, a, n_{A}, and ne are as follows.
r: The radius
a: The radius of the first region 111 of the core 11
n_{A}: The refractive index value at the center of the core 11, namely, at r=0
n_{B}: The refractive index value at the outer edge of the first region 111 of the core 11

The refractive index n1 at the outer edge 11b of the core 11 or, when the second region 112 is provided, the refractive index n1 of the second region 112 can be, for example, 1.3 or more and 1.6 or less at a wavelength of 850 nm.

When the core 11 includes the second region 112, the thickness of the second region 112 is, for example, 5 μm or less, and is preferably 0.5 μm or less.

### (Trench 12)

In the POF 10 according to the present embodiment, the trench 12 includes, for example, a second resin. The trench 12 may include the second resin as its main component. Here, saying that the trench 12 includes the second resin as its main component means that the second resin is a component whose content is highest in the trench 12 on a mass basis. The second resin content in the trench 12 may be 80 mass % or more, 90 mass % or more, or 95 mass % or more. The trench 12 may consist of the second resin. The trench 12 may further include an additive in addition to the second resin.

The second resin included in the trench 12 is not limited to a particular one as long as the second resin is a resin having high transparency. Examples of the second resin are the same as those mentioned as examples of the resin that can be used as the first resin. As in the case of the first resin, a fluorine-containing resin is suitably used as the second resin.

The second resin of the trench 12 is preferably a fluorine-containing resin including a fluorine-containing polymer. Hereinafter, the fluorine-containing resin included in the trench 12 is referred to as a second fluorine-containing resin, and the fluorine-containing polymer included in the second fluorine-containing resin is referred to as a second fluorine-containing polymer.

Those mentioned as examples of the fluorine-containing resin that can be used as the first fluorine-containing resin can be used as the second fluorine-containing resin.

A fluorine-containing resin including a fluorine-containing polymer and a fluorine-containing plasticizer can be used as the second fluorine-containing resin, the fluorine-containing polymer including a structural unit (E) represented by the following formula (12), the fluorine-containing polymer having an amorphous structure.

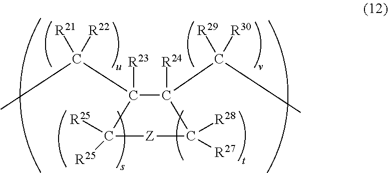

In the formula (12), Z represents an oxygen atom, a single bond, or —OC(R³¹R³²)O—, R²¹ to R³² each independently represent a fluorine atom, a perfluoroalkyl group having 1 to 5 carbon atoms, or a perfluoroalkoxy group having 1 to 5 carbon atoms. “Perfluoro” indicates that every hydrogen atom bonded to a carbon atom is substituted by a fluorine atom. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom. Symbols s and t are each independently 0 to 5, and s+t is an integer of 1 to 6 (when Z is —OC(R³¹R³²)O—, s+t may be 0). The symbols u and v are each independently 0 or 1.

The fluorine-containing polymer including the structural unit (E) may further include a structural unit (F) represented by the following formula (13).

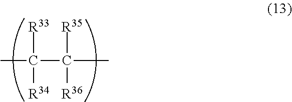

In the formula (13), R³³ to R³⁶ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

When the second fluorine-containing polymer is the above copolymer, a proportion between the structural unit (E) and the structural unit (F) is any proportion and is not limited to a particular one.

The second fluorine-containing polymer is preferably, for example, at least one selected from the group consisting of a fluorine-containing polymer A and a fluorine-containing polymer B shown below.

The fluorine-containing polymer A includes a structural unit (G) represented by the following formula (14) and a structural unit (H) represented by the following formula (15). In the following formula (14), R²³, R²⁴, R³¹, and R³² are as described in the above formula (12).

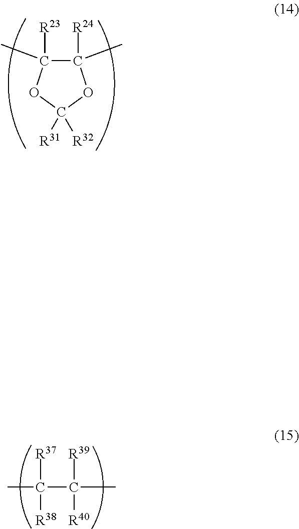

In the formula (15), R³⁷ to R⁴⁰ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The fluorine-containing polymer B includes a structural unit (I) represented by the following formula (16). In the following formula (16), R²¹ to R²⁴, R²⁷ to R³⁰, R³¹, and R³² are as described in the above formula (12).

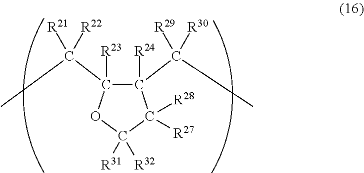

The fluorine-containing polymer A and the fluorine-containing polymer B have very high transparency, and moreover can have a very low refractive index compared to a common refractive index of the first fluorine-containing resin used as the material of the core 11. Therefore, the second fluorine-containing resin including at least one selected from the group consisting of the fluorine-containing polymer A and the fluorine-containing polymer B as the second fluorine-containing polymer can maintain high transparency of the trench 12 and can decrease the refractive index further. That makes it possible to widen a difference between the refractive index of the core 11 and that of the trench 12 even greater. As a result, the effect of the trench 12's keeping light within the core 11 is further enhanced and it becomes easier for the POF 10 to achieve a low transmission loss.

The second fluorine-containing polymer preferably includes a structural unit (J) represented by the following formula (17).

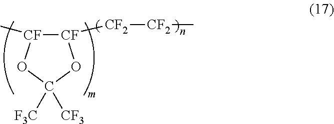

In the formula (17), m and n are any integer.

The second fluorine-containing polymer is included in the second fluorine-containing resin used as the second resin. A second glass transition temperature Tg₂ of the second resin is, for example, but not particularly limited to, 100° C. to 150° C., and may be 105° C. or higher or 125° C. or higher.

The refractive index n2 of the trench 12 is required to be designed with reference to the refractive index n1 at the outer edge 11b of the core 11 and is not limited to a particular one. The refractive index n2 of the trench 12 is preferably, for example, 1.32 or more and 1.34 or less at a wavelength of 850 nm.

### (First Modification of POF)

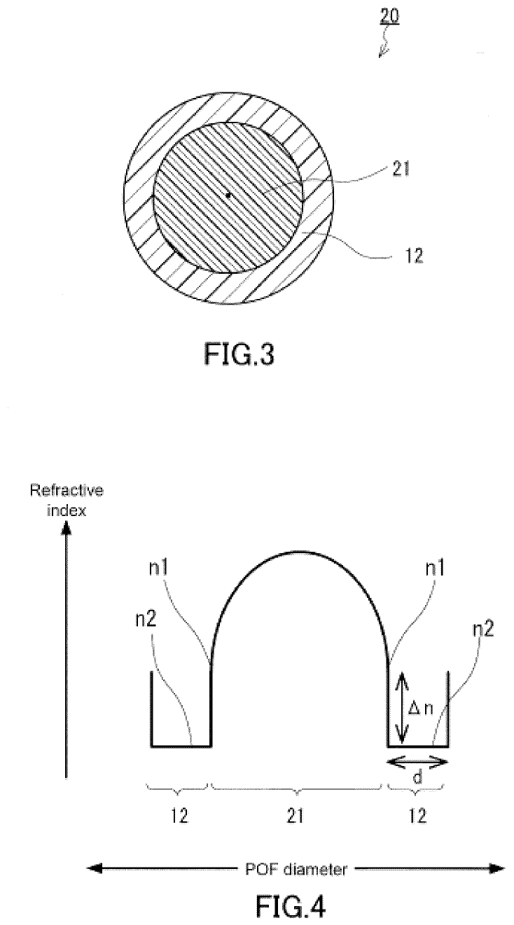

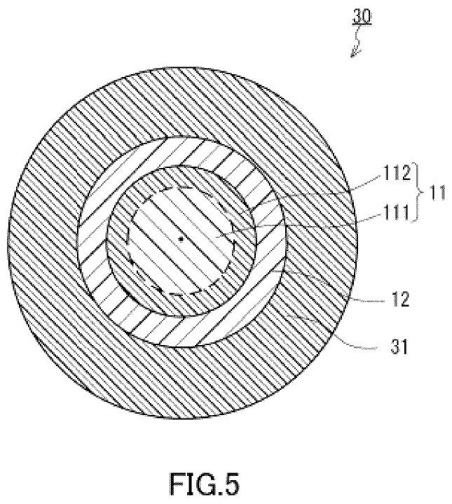

FIG. 3 is a schematic diagram showing an example of a cross-sectional structure of a first modification of the POF of the present embodiment. FIG. 4 is a graph showing a profile of the refractive index of the POF of the first modification. The POF shown in FIG. 3 includes a core 21 and the trench 12 provided around the core 21. The core 21 of the POF 20 is composed only of the first region having a refractive-index distribution. That is, the POF 20 includes the core 21 not including the second region, and the core 21 as a whole has a refractive-index distribution. To be more specific, as shown in FIG. 2, a center of the core 21 has the maximum refractive index, and the refractive index of the core 21 gradually decreases toward the trench 12. Additionally, the refractive index in the trench 12 is, for example, constant. As described above, saying that “the refractive index is constant” means that the difference between the maximum refractive index and the minimum refractive index is 0.003 or less. Hence, saying that “the refractive index in the trench 12 is constant” means that the difference between the maximum refractive index and the minimum refractive index in the trench 12 is 0.003 or less. As shown in FIG. 4, a POF diameter refers to the diameter of a POF including the core 21 and the trench 12. Like the POF 10, the POF 20 configured as above can have a small bending loss and achieve a low band in a short distance.

### (Second Modification of POF)

FIG. 5 shows a second modification of the POF of the present embodiment. A POF 30 shown in FIG. 5 has a configuration in which the POF 10 is further provided with a reinforcing layer 31 disposed on the outer circumference of the trench 12. In other words, the POF 30 includes the core 11, the reinforcing layer 31, and the trench 12 provided between the core 11 and the reinforcing layer 31. The reinforcing layer 31 is provided to enhance the mechanical strength of the POF. For example, any material and configuration of reinforcing layers of known POFs can be applied to those of the reinforcing layer 31. Examples of the material of the reinforcing layer 31 include engineering plastics such as polycarbonates, polyesters, cycloolefin polymers, cycloolefin copolymers, polytetrafluoroethylene (PTFE), modified PTFEs, tetrafluoroethylene-perfluoroalkoxyethylene copolymers (PFA), and copolymers and mixtures thereof.

### (POF Manufacturing Method)

The POF of the present embodiment is manufactured, for example, by melt spinning. That is, one example of the method for manufacturing the POF of the present embodiment includes:
producing a fiber-shaped molded body made of a core material by melting the core material and extrusion-molding the molten core material into a fiber shape; and
producing a layered body by melting a trench material and extrusion-molding the molten trench material to coat a surface of the molded body, the layered body including the core material and the trench material concentrically layered. The above core material includes, for example, the first resin. The above trench material includes, for example, the second resin.

When the fiber-shaped molded body made of the core material is produced, a core inner layer portion may be formed first by extrusion-molding a first core material including a refractive index modifier, and extrusion-molding of a second core material may be performed subsequently so as to coat an outer circumference of the core inner layer portion 2 made of the first core material 1a. In this case, the core 11 including the first region 111 having a refractive-index distribution can be formed by diffusing the refractive index modifier included in the first core material toward a core outer circumferential portion made of the second core material. In the case of forming the core 11 including the second region 112, for example, conditions (e.g., a diffusion temperature and a diffusion time) for diffusing the refractive index modifier (for example, by thermal diffusion), amounts of the first core material discharged and the second core material discharged, and the like are adjusted to form the second region 112 of the core 11, the second region 112 having the constant refractive index n1.

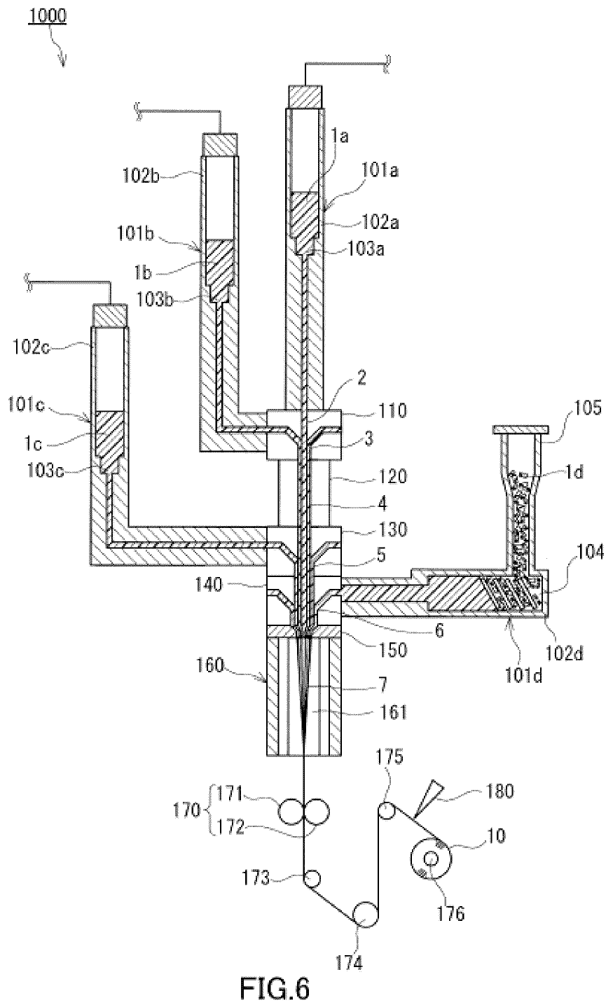

FIG. 6 is a schematic cross-sectional view showing an example of a manufacturing apparatus that can be used to manufacture the POF 30 shown in FIG. 5.

An apparatus 1000 shown in FIG. 6 includes a first extrusion apparatus 101a for extrusion molding of the first core material, a second extrusion apparatus 101b for extrusion molding of the second core material, a third extrusion apparatus 101c for extrusion molding of the trench material, and a fourth extrusion apparatus 101d for formation of a coating layer.

The first extrusion apparatus 101a includes a first holding portion 102a that holds the first core material 1a and a first extrusion portion 103a that extrudes the first core material 1a held in the first holding portion 102a from the first holding portion 102a. The first extrusion apparatus 101a is further provided with a heating unit (not illustrated) so that the first core material 1a can be molten in the first holding portion 102a and that the molten first core material 1a can be kept in a molten state until molded. The first core material (preform) 1a in a rod shape is molten by being put in the first holding portion 102a through an upper opening portion of the first holding portion 102a and then being heated in the first holding portion 102a.

In the first extrusion apparatus 101a, the first core material 1a is extruded outside from the first holding portion 102a through the first extrusion portion 103a by gas to form the core inner layer portion 2. The first core material 1a extruded through the first extrusion portion 103a to form the core inner layer portion 2 then moves vertically downward to be supplied to the first chamber 110.

The second extrusion apparatus 101b includes a second holding portion 102b that holds a second core material 1b and a second extrusion portion 103b that extrudes the second core material 1b held in the second holding portion 102b from the second holding portion 102b. The second extrusion apparatus 101b extrudes the second core material in a molten state to coat an outer circumference of the core inner layer portion 2 made of the first core material 1a extruded from the first extrusion apparatus 101a. Specifically, the second core material extruded from the second extrusion apparatus 101b is supplied to the first chamber 110. In the first chamber 110, a core outer circumferential portion 3 coating the outer circumference of the core inner layer portion 2 can be formed by coating the core inner layer portion 2 made of the first core material 1a with the second core material. A layered body 4 composed of the core inner layer portion 2 and the core outer circumferential portion 3 coating the outer circumference of the core inner layer portion 2 moves from the first chamber 110 to a diffusion tube 120 disposed vertically under the first chamber 110. A heater (not illustrated) for heating the layered body 4 is disposed in the diffusion tube 120. The diffusion tube 120 diffuses a dopant such as a refractive index modifier toward the core outer circumferential portion 3, the dopant being included in the core inner layer portion 2 of the layered body 4 passing through the diffusion tube 120. That is, the core inner layer portion 2 and the core outer circumferential portion 3 form a core eventually.

The third extrusion apparatus 101c includes a third holding portion 102c that holds a trench material 1c and a third extrusion portion 103c that extrudes the trench material 1c held in the third holding portion 102c from the third holding portion 102c. The third extrusion apparatus 101c extrudes the trench material 1c in a molten state to coat an outer circumference of the layered body 4 having passed through the diffusion tube 120. Specifically, the trench material 1c extruded from the third extrusion apparatus 101c is supplied to the second chamber 130. In the second chamber 130, a trench 5 coating the outer circumference of the layered body 4 (namely, the core) can be formed by coating the core with the trench material 1c. The layered body 4 is hereinafter referred to as the core 4. The layered body composed of the core 4 and the trench 5 moves from the second chamber 130 to a third chamber 140 disposed vertically under the second chamber 130.

The fourth extrusion apparatus 101d includes a fourth holding portion 102d that holds a coating layer material 1d, a screw 104 disposed in the fourth holding portion 102d, and a hopper 105 connected to the fourth holding portion 102d. In the fourth extrusion apparatus 101d, for example, the coating layer material 1d in a pellet shape is supplied to the fourth holding portion 102d through the hopper 105. The coating layer material 1d supplied to the fourth holding portion 102d becomes soft and flowable by being kneaded by the screw 104 under heating. The softened coating layer material 1d is extruded from the fourth holding portion 102d by the screw 104.

The coating layer material 1d extruded from the fourth extrusion apparatus 101d is supplied to the third chamber 140. In the third chamber 140, a coating layer 6 coating an outer circumference of the trench 5 is formed by coating a surface of the layered body composed of the core 4 and the trench 5 with the coating layer material 1d.

A layered body 7 including the core 4, the trench 5, and the coating layer 6 concentrically layered flows from the third chamber 140 into an internal flow path through an inlet of the nozzle 150. The layered body 7 passes through the internal flow path to be reduced in diameter, and is then discharged into a fiber shape through an outlet of the nozzle 150.

The layered body 7 discharged into a fiber shape through the outlet of the nozzle 150 flows into an internal space 161 of a cooling pipe 160. The layered body 7 is cooled while passing through the internal space 161. The layered body 7 is then discharged from the cooling pipe 160 through an opening portion. The layered body 7 discharged from the cooling pipe 160, for example, passes between two rolls 171 and 172 of a nip roll 170 and then along guide rolls 173 to 175, and is wound as the POF 10 onto a winding roll 176. A displacement meter 180 for measuring the outer diameter of the POF 10 may also be disposed near the winding roll 176, for example, between the guide roll 175 and the winding roll 176.

The POF according to the present embodiment can also be included in optical cords, active optical cables, and the like.

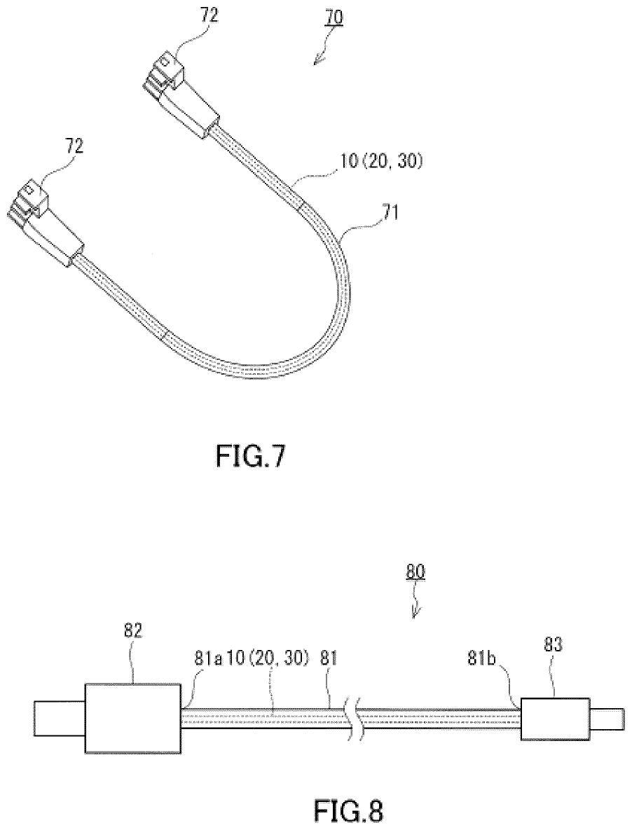

FIG. 7 is a schematic diagram showing an example of an optical cord including the POF 10 (the POF 20, or the POF 30) of the present embodiment. An optical cord 70 shown in FIG. 7 includes: a cable 71 including the POF 10 (the POF 20, or the POF 30) of the present embodiment; and a connector 72 attached to at least one end portion of the cable 71.

FIG. 8 is a schematic diagram showing an example of an active optical cable including the POF 10 (the POF 20, or the POF 30) of the present embodiment. An active optical cable 80 shown in FIG. 8 includes: a cable 81 including the POF 10 (the POF 20, or the POF 30) of the present embodiment; a first connector 82 attached to a first end portion 81a of the cable 81 and including a first converter (not illustrated) that converts an electrical signal into an optical signal; and a second connector 83 attached to a second end portion 81b of the cable 81 and including a second converter (not illustrated) that converts an optical signal into an electrical signal.

### Second Embodiment

A POF of a second embodiment of the present disclosure will be described.

The POF of the second embodiment includes: a core including a first region in which a refractive index decreases in a direction from a center of the core toward an outer edge of the core; and a trench disposed on an outer circumference of the core. The refractive index n2 of the trench is lower than the refractive index n1 at the outer edge of the core, and a thickness d (μm) of the trench is 2 μm or more and less than 5 μm.

Since the POF of the second embodiment includes the trench having a thickness in the above range, the POF of the second embodiment can reduce degradation of the band, the degradation being caused by reflection of light incident on the trench. Hence, the POF of the second embodiment can have a small bending loss and achieve a degraded band in a short distance. Furthermore, since the POF of the second embodiment includes the trench having a thickness in the above range, the POF of the second embodiment can reduce heat-caused degradation of the band and thus can improve the heat resistance too. As described above, the POF of the second embodiment improves the heat resistance as well as the band in a short distance.

To further improve the band and even the heat resistance, the thickness d (μm) of the trench of the POF of the second embodiment is preferably 2 μm or more and 4.5 μm or less.

Like the POF of the first embodiment, the POF of the second embodiment can have the POF structures shown in FIGS. 1 to 5. The details of the constituents (e.g., the core, the trench, and the coating layer) described in the first embodiment and included in the POFs shown in FIGS. 1 to 5 are applicable to the POF of the second embodiment.

The POF manufacturing method and the manufacturing apparatus described in the first embodiment are also applicable to manufacturing of the POF of the second embodiment.

Like the POF of the first embodiment, the POF of the second embodiment can be included in an optical cord as shown in FIG. 7 and an active optical cable as shown in FIG. 8.

### EXAMPLES

### Example 1-1

### [Production of First Fluorine-Containing Resin]

A polymer of perfluoro-4-methyl-2-methylene-1,3-dioxolane (PFMMD) was prepared as the first fluorine-containing resin. The perfluoro-4-methyl-2-methylene-1,3-dioxolane was synthesized by synthesizing 2-carbomethyl-2-trifluoromethyl-4-methyl-1,3-dioxolane, fluorinating the 2-carbomethyl-2-trifluoromethyl-4-methyl-1,3-dioxolane, and then decarboxylating the resulting carboxylic acid salt. In the polymerization of the perfluoro-4-methyl-2-methylene-1,3-dioxolane, perfluorobenzyl peroxide was used as a polymerization initiator.

The synthesis of 2-carbomethyl-2-trifluoromethyl-4-methyl-1,3-dioxolane, the fluorination of 2-carbomethyl-2-trifluoromethyl-4-methyl-1,3-dioxolane, the synthesis of perfluoro-4-methyl-2-methylene-1,3-dioxolane, and the polymerization of perfluoro-4-methyl-2-methylene-1,3-dioxolane will be described hereinafter in details.

<Synthesis of 2-carbomethyl-2-trifluoromethyl-4-methyl-1,3-dioxolane>

A 3 L three-neck flask equipped with a water-cooled chiller, a thermometer, a magnetic stirrer, and a pressure equalizing dropping funnel were prepared. An amount of 139.4 g (1.4 mols in total) of a mixture of 2-chloro-1-propanol and 1-chloro-2-propanol was put in the flask. The flask was cooled to 0° C., methyl trifluoropyruvate was slowly added thereto, and the contents were stirred for two hours. An amount of 100 mL of dimethyl sulfoxide (DMSO) and 194 g of potassium carbonate were added thereto over one hour followed by eight-hour stirring to obtain a reaction mixture. The reaction mixture generated was mixed with 1 L of water, and an aqueous phase of the resulting mixture was separated out. After extraction was performed with dichloromethylene, the dichloromethylene solution was mixed with an organic reaction mixture phase. The resulting solution was dried with magnesium sulfate. After the removal of the solvent, 245.5 g of an unrefined product was obtained. This unrefined product was fractionated under a reduced pressure (12 Torr) to obtain 230.9 g of a purified product, 2-carbomethyl-2-trifluoromethyl-4-methyl-1,3-dioxolane. The boiling point of the purified product was 77 to 78° C., and the percentage yield was 77%. HNMR and ¹⁹F NMR were used to confirm that the obtained purified product was 2-carbomethyl-2-trifluoromethyl-4-methyl-1,3-dioxolane.

HNMR (ppm): 4.2 to 4.6, 3.8 to 3.6 (CHCH₂, multiplet, 3H), 3.85 to 3.88 (COOCH₃, multiplet, 3H), 1.36 to 1.43 (CCH₃, multiplet, 3H)

¹⁹F NMR (ppm): −81.3 (CF₃, s, 3F)

### <Fluorination of 2-Carbomethyl-2-Trifluoromethyl-4-Methyl-1,3-Dioxolane>

An amount of 4 L of 1,1,2-trichlorotrifluoroethane was introduced into a 10 L stirred reaction vessel. In the stirred reaction vessel, nitrogen and fluorine were allowed to flow at a flow rate of 1340 cc/min and 580 cc/min, respectively, to create a nitrogen-fluorine atmosphere. Five minutes later, 290 g of the 2-carbomethyl-2-trifluoromethyl-4-methyl-1,3-dioxolane prepared beforehand was dissolved in 750 ml of a 1,1,2-trichlorotrifluoroethane solution, which was then added into the reaction vessel at 0.5 ml/min. The reaction vessel was cooled to 0° C. After the dioxolan was all added over 24 hours, the fluorine gas flow was stopped. The nitrogen gas was purged, and subsequently an aqueous potassium hydroxide solution was added until the mixture became weak alkaline.

After a volatile substance was removed under a reduced pressure, the reaction vessel was cooled. The cooling was followed by a 48-hour drying under a reduced pressure at 70° C. to obtain a solid reaction product. The solid reaction product was dissolved in 500 ml of water, to which an excessive amount of hydrochloric acid was added to separate the mixture into an organic phase and an aqueous phase. The organic phase was separated and distilled under a reduced pressure to obtain perfluoro-2,4-dimethyl-1,3-dioxolane-2-carboxylic acid. The boiling point of the main distillate was 103° C.-106° C./100 mmHg. The percentage yield of the fluorination was 85%.

### <Synthesis of Perfluoro-4-Methyl-2-Methylene-1,3-Dioxolane>

The above distillate was neutralized with an aqueous potassium hydroxide solution to obtain perfluoro-2,4-dimethyl-2-potassium carboxylate-1,3-dioxolane. This potassium salt was vacuum-dried at 70° C. for one day. The salt was decomposed at 250° C. to 280° C. under a nitrogen or argon atmosphere. Through condensation in a cold trap cooled at −78° C., perfluoro-4-methyl-2-methylene-1,3-dioxolane was obtained at a percentage yield of 82%. The boiling point of the product was 45° C./760 mmHg. The product was identified by ¹⁹F NMR and GC-MS.

¹⁹F NMR: −84 ppm (3F, CF₃), −129 ppm (2F, ═CF₂)

GC-MS: m/e244 (Molecular ion) 225, 197, 169, 150, 131, 100, 75, 50.

### <Polymerization of Perfluoro-4-Methyl-2-Methylene-1,3-Dioxolane>

An amount of 100 g of the perfluoro-4-methyl-2-methylene-1,3-dioxolane obtained in the above manner and 1 g of perfluorobenzyl peroxide were put in a glass tube, which was then sealed. After oxygen in the system was removed by freeze-pump-thaw cycling, the glass tube was charged with argon and then heated at 50° C. for several hours. The contents thereby turned solids, which were further heated at 70° C. overnight to obtain 100 g of a transparent stick.

The transparent stick obtained was dissolved in Fluorinert FC-75 (manufactured by Sumitomo 3M), and the resulting solution was poured onto a glass sheet to obtain a thin polymer film. The polymer had a glass transition temperature of 117° C., and was completely amorphous. The transparent stick was dissolved in a hexafluorobenzene solution, to which chloroform was added for precipitation. The product was thereby purified. A polymer resulting from the purification had a glass transition temperature of approximately 131° C. This polymer was used as the first fluorine-containing resin.

### [Refractive Index Modifier]

A chlorotrifluoroethylene oligomer (molecular weight: 585) was used as a refractive index modifier. Specifically, distillation of DAIFLOIL #10 manufactured by DAIKIN INDUSTRIES, LTD. was performed to take out only a component having a molecular weight of 585. The component taken out and having a molecular weight of 585 was filtered through a filter “DFA1ANDESW44” (manufactured by Pall Corporation) having a pore diameter of 40 nm to obtain a refractive index modifier.

### [First Core Material]

The first fluorine-containing resin produced in the above manner was dissolved in Vertrel XF-UP (manufactured by Chemours-Mitsui Fluoroproducts Co., Ltd.) serving as a solvent. The solution was filtered twice by a filter “LP J-CTA-001-N3” (manufactured by ROKI TECHNO CO., LTD.) having a pore diameter of 100 nm, and the filtrate was dropped on a Hastelloy container heated at 260° C. to evaporate the solvent to dryness. The filtered fluorine-containing resin obtained by the drying and the above refractive index modifier were molten and mixed at 260° C. to produce a resin composition. The refractive index modifier concentration in the resin composition was 12 mass %. This resin composition was used as the first core material.

### [Second Core Material]

The first fluorine-containing resin produced in the above manner was filtered in the same manner as for the filtration of the fluorine-containing resin in the production of the first core material, and thus a filtered fluorine-containing resin was obtained. This filtered fluorine-containing resin was used as the second core material.

### [Trench Material]

The second fluorine-containing resin was prepared as a trench material. “Teflon AF 1600” (manufactured by Chemours-Mitsui Fluoroproducts Co., Ltd.) serving as the second fluorine-containing resin and “Fomblin YR” (manufactured by Solvay S.A.) serving as a viscosity modifier were dissolved in Vertrel XF-UP (manufactured by Chemours-Mitsui Fluoroproducts Co., Ltd.) serving as a solvent. A mixing ratio between “Teflon AF 1600” and “Fomblin YR” was “Teflon AF1600”: “Fomblin YR”=7:3 in mass. The solution obtained was filtered by a filter “LPA-SLF-003-N2” (manufactured by ROKI TECHNO CO., LTD.) having a pore diameter of 300 nm, and the filtrate was dropped on a Hastelloy container heated at 260° C. to evaporate the solvent to dryness. The resin composition obtained by the drying was used as a trench material.

### [Coating Layer Material]

Xylex (manufactured by SABIC Innovative Plastics; glass transition temperature: 113° C.) was used as a coating layer material.

### [Production of POF]

A POF having the same configuration as that of the POF 20 as shown in FIG. 5 was produced by melt spinning using the first core material, the second core material, the trench material, and the coating layer material prepared in the above manners. In the present example, a manufacturing apparatus as shown in FIG. 6 was used to manufacture the POF.

In the present example, the diffusion tube 120 had an inner diameter of 6.3 mm. The length of the diffusion tube 120 was set so that the diffusion time would be 120 minutes.

In the present example, the first core material had a melting temperature of 250° C., the second core material had a melting temperature of 255° C., the trench material had a melting temperature of 260° C., and the coating layer material had a melting temperature of 240° C. The temperature of the diffusion tube 120 was set to 275° C. A core was formed using the first core material and the second core material. The temperature at which the layered body 7 composed of the core, the trench, and the coating layer was drawn was 240° C.

Melt extrusion was performed in which volume rates of the materials discharged was the second core material: 1.76; the trench material: 0.67; and the coating layer material: 45.53, with respect to the first core material: 1.

In the first chamber 110 as shown in FIG. 6, the temperature of a joining mold used to coat the core inner layer portion made of the first core material with the second core material was set to 260° C. In the second chamber 130 as shown in FIG. 6, the temperature of a joining mold used to coat the core with the trench material was set to 205° C. In the third chamber 140 as shown in FIG. 6, the temperature of a joining mold used to coat the surface of the layered body composed of the core and the trench with the coating layer material was set to 250° C.

The POF produced in Example 1-1 was measured by the methods described below. The core diameter (the outer diameter of the core) was 50 μm, the outer diameter of the trench was 56 μm (that is, the thickness of the trench was 3 μm), and the outer diameter of the coating layer was 230 μm.

The refractive index n1 at the outer edge of the core of the POF produced in Example 1-1 was 1.330. The refractive index n2 of the trench thereof was 1.324. The refractive index n1 at the outer edge of the core of the POF produced in Example 1-1 and the refractive index n2 of the trench thereof can be measured by the method described in the embodiment of the present disclosure; in this Example, however, the refractive index of the fluorine-containing resin used as the second core material was regarded as the refractive index n1 at the outer edge of the core, and the refractive index n2 of the trench material used was regarded as the refractive index of the trench. The refractive indices of the second core material and the trench material were measured by the method described below. The refractive index n1 at the outer edge of the core of the POF and the refractive index n2 of the trench thereof were determined in the same manner for Examples 1-2 to 1-6, Examples 2-1 to 2-8, and Comparative Example 1 below.

### Example 1-2

A POF of Example 1-2 was produced in the same manner as in Example 1-1, except that, in the production of the POF, the volume rates of the materials discharged were changed to the second core material: 1.76; the trench material: 0.90; and the coating layer material: 45.30, with respect to the first core material: 1.

The POF produced in Example 1-2 was measured by the methods described below. The core diameter (the outer diameter of the core) was 50 μm, the outer diameter of the trench was 58 μm (that is, the thickness of the trench was 4 μm), and the outer diameter of the coating layer was 230 μm.

### Example 1-3

A POF of Example 1-3 was produced in the same manner as in Example 1-1, except that, in the production of the POF, the volume rates of the materials discharged were changed to the second core material: 1.76; the trench material: 1.15; and the coating layer material: 45.06, with respect to the first core material: 1.

The POF produced in Example 1-3 was measured by the methods described below. The core diameter (the outer diameter of the core) was 50 μm, the outer diameter of the trench was 60 μm (that is, the thickness of the trench was 5 μm), and the outer diameter of the coating layer was 230 μm.

### Example 1-4

In the production of the POF, the volume rates of the materials discharged were changed to the second core material: 1.51; the trench material: 1.52; and the coating layer material: 48.70, with respect to the first core material: 1. Additionally, an inner diameter of the diffusion tube 120 was 4 mm, and the length of the diffusion tube 120 was set so that the diffusion time would be 16 minutes. A POF of Example 1-4 was produced in the same manner as in Example 1-1, except for these changes.

The POF produced in Example 1-4 was measured by the methods described below. The core diameter (the outer diameter of the core) was 50 μm, the outer diameter of the trench was 63 μm (that is, the thickness of the trench was 6.5 μm), and the outer diameter of the coating layer was 230 μm.

### Example 1-5

In the production of the POF, the volume rates of the materials discharged were changed to the second core material: 1.51; the trench material: 1.93; and the coating layer material: 48.3, with respect to the first core material: 1. Additionally, an inner diameter of the diffusion tube 120 was 4 mm, and the length of the diffusion tube 120 was set so that the diffusion time would be 16 minutes. A POF of Example 1-5 was produced in the same manner as in Example 1-1, except for these changes.

The POF produced in Example 1-5 was measured by the methods described below. The core diameter (the outer diameter of the core) was 50 μm, the outer diameter of the trench was 66 μm (that is, the thickness of the trench was 8 μm), and the outer diameter of the coating layer was 230 μm.

### Example 1-6

Regarding the trench material, a mixing ratio between “Teflon AF1600” and “Fomblin YR” was changed to “Teflon AF1600”: “Fomblin YR”=82:18 in mass. Furthermore, in the production of the POF, the volume rates of the materials discharged were changed to the second core material: 1.76; the trench material: 0.44; and the coating layer material: 45.75, with respect to the first core material: 1. A POF of Example 1-6 was produced in the same manner as in Example 1-1, except for these changes.

### Example 2-1

In the production of the POF, the volume rates of the materials discharged were changed to the second core material: 1.52; the trench material: 0.44; and the coating layer material: 106.8, with respect to the first core material: 1. A POF of Example 2-1 was produced in the same manner as in Example 1-1, except for these changes.

The POF produced in Example 2-1 was measured by the methods described below. The core diameter (the outer diameter of the core) was 50.0 μm, the outer diameter of the trench was 54.2 μm (that is, the thickness of the trench was 2.1 μm), and the outer diameter of the coating layer was 330 μm.

The refractive index n1 at the outer edge of the core of the POF produced in Example 2-1 was 1.330. The refractive index n2 of the trench thereof was 1.324.

### Example 2-2

A POF of Example 2-2 was produced in the same manner as in Example 1-1, except that, in the production of the POF, the volume rates of the materials discharged were changed to the second core material: 1.52; the trench material: 0.64; and the coating layer material: 106.6, with respect to the first core material: 1.

The POF produced in Example 2-2 was measured by the methods described below. The core diameter (the outer diameter of the core) was 50.0 μm, the outer diameter of the trench was 56.0 μm (that is, the thickness of the trench was 3.0 μm), and the outer diameter of the coating layer was 330 μm.

### Example 2-3

A POF of Example 2-3 was produced in the same manner as in Example 1-1, except that, in the production of the POF, the volume rates of the materials discharged were changed to the second core material: 1.52; the trench material: 0.80; and the coating layer material: 50.0, with respect to the first core material: 1.

The POF produced in Example 2-3 was measured by the methods described below. The core diameter (the outer diameter of the core) was 50.0 μm, the outer diameter of the trench was 57.4 μm (that is, the thickness of the trench was 3.7 μm), and the outer diameter of the coating layer was 230 μm.

### Example 2-4

A POF of Example 2-4 was produced in the same manner as in Example 1-1, except that, in the production of the POF, the volume rates of the materials discharged were changed to the second core material: 1.52; the trench material: 0.82; and the coating layer material: 106.4, with respect to the first core material: 1.

The POF produced in Example 2-4 was measured by the methods described below. The core diameter (the outer diameter of the core) was 50.0 μm, the outer diameter of the trench was 57.6 μm (that is, the thickness of the trench was 3.8 μm), and the outer diameter of the coating layer was 330 μm.

### Example 2-5

A POF of Example 2-5 was produced in the same manner as in Example 1-1, except that, in the production of the POF, the volume rates of the materials discharged were changed to the second core material: 1.52; the trench material: 0.85; and the coating layer material: 106.4, with respect to the first core material: 1.

The POF produced in Example 2-5 was measured by the methods described below. The core diameter (the outer diameter of the core) was 50.0 μm, the outer diameter of the trench was 57.8 μm (that is, the thickness of the trench was 3.9 μm), and the outer diameter of the coating layer was 330 μm.

### Example 2-6

A POF of Example 2-6 was produced in the same manner as in Example 1-1, except that, in the production of the POF, the volume rates of the materials discharged were changed to the second core material: 1.52; the trench material: 0.96; and the coating layer material: 49.8, with respect to the first core material: 1.

The POF produced in Example 2-6 was measured by the methods described below. The core diameter (the outer diameter of the core) was 50.0 μm, the outer diameter of the trench was 58.8 μm (that is, the thickness of the trench was 4.4 μm), and the outer diameter of the coating layer was 230 μm.

### Example 2-7

A POF of Example 2-7 was produced in the same manner as in Example 1-1, except that, in the production of the POF, the volume rates of the materials discharged were changed to the second core material: 1.52; the trench material: 1.11; and the coating layer material: 49.7, with respect to the first core material: 1.

The POF produced in Example 2-7 was measured by the methods described below. The core diameter (the outer diameter of the core) was 50.0 μm, the outer diameter of the trench was 60.0 μm (that is, the thickness of the trench was 5 μm), and the outer diameter of the coating layer was 230 μm.

### Example 2-8

A POF of Example 2-8 was produced in the same manner as in Example 1-1, except that, in the production of the POF, the volume rates of the materials discharged were changed to the second core material: 1.52; the trench material: 1.87; and the coating layer material: 105.4, with respect to the first core material: 1.

The POF produced in Example 2-8 was measured by the methods described below. The core diameter (the outer diameter of the core) was 50.0 μm, the outer diameter of the trench was 66.0 μm (that is, the thickness of the trench was 8 μm), and the outer diameter of the coating layer was 330 μm.

### Comparative Example 1

A POF of Comparative Example 1 was produced in the same manner as in Example 1-1, except that the trench material was not discharged so as not to provide a trench (that is, the amount of the trench material discharged was 0).

The POF produced in Comparative Example 1 was measured by the methods described below. The core diameter (the outer diameter of the core) was 50 μm, the thickness of the trench was 0 μm, and the outer diameter of the coating layer was 230 μm.

### Comparative Example 2

GigaPOF-50SR (manufactured by Chromis Fiberoptics) was prepared as a POF of Comparative Example 2. The POF of Comparative Example 2 was not provided with a trench. The refractive index n1 at the outer edge of the core of the POF of Comparative Example 2 was 1.338.

### Comparative Example 3

FONTEX (manufactured by AGC Inc.) was prepared as a POF of Comparative Example 3. The thickness of the trench of the POF of Comparative Example 3 was 5 μm. The refractive index n1 at the outer edge of the core of the POF of Comparative Example 3 was 1.338, and the refractive index n2 of the trench thereof was 1.325. The values are those published by AGC Inc.

### (Evaluation of POF)

### [Measurement of Core Diameter]

The core diameter was determined by an NFP method, which is one of the methods according to IEC 60793-1-20 and IEC 60793-2-40 subcategory A4h, using light with a wavelength of 850 nm. Specifically, using M-Scope Type S manufactured by SYNERGY OPTOSYSTEMS CO., LTD., LED light with a wavelength of 850 nm was allowed to be incident on a first end of the POF having a length of 6 m. A light intensity distribution of output light output from a second end of the POF was determined, and a diameter where the intensity is 5% of a peak of the light intensity was measured and defined as the core diameter.

### [Measurement of Outer Diameter of Trench]

The POF to be measured was cut to a length of several centimeters, and the outer diameter of the trench thereof was measured with a digital microscope. Specifically, the POF was set such that the axis of the POF was perpendicular to a specimen stub of VHX-950F manufactured by Keyence Corporation. A first end of the POF was irradiated with a light source attached to the microscope, and transmitted light output from a second end of the POF was observed to measure the outer diameter of the coating layer.

### [Measurement of Outer Diameter of Coating Layer]

The POF to be measured was cut to a length of several centimeters, and the outer diameter of the coating layer thereof was measured with a digital microscope. Specifically, the POF was set such that the axis of the POF was perpendicular to a specimen stub of VHX-950F manufactured by Keyence Corporation. A first end of the POF was irradiated with a light source attached to the microscope, and transmitted light output from a second end of the POF was observed to measure the outer diameter of the coating layer.

### [Measurement of Refractive Index]

The second core material and the trench material were each molded by hot pressing at approximately 210° C. to obtain sheets having a thickness of approximately 100 μm. The sheets were each set in a prism coupler (model: 2010/M) manufactured by Metricon Corporation to determine refractive indices of the second core material and the trench material at a wavelength of 850 nm.

### [Evaluation of Band (POFs of Examples 1-1 to 1-6 and Comparative Examples 1 to 3)]

Bands of the POFs of Examples 1-1 to 1-6 and Comparative Examples 1 to 3 were measured for distances of 5 m and 20 m by a pulse method which is one of the methods according to IEC 60793-1-41. To measure the bands of the POFs for such very short distances, an apparatus capable of oscillating ultra-high-speed pulses was used as an optical pulse generator and an apparatus capable of recognizing images in a short time was used as a light receiver. Specifically, the bands were measured by the following method.

InSight X3+ manufactured by Spectra-Physics, Inc. was used as the optical pulse generator. A laser with a wavelength of 850 nm was oscillated with this optical pulse generator. The oscillated laser was coupled to an OM1 fiber (“M31L01-OM1, 0.275 NA, Graded-Index Patch Cable” manufactured by Thorlabs, Inc.) through a lens, and mode scrambling was performed with FM-1 manufactured by Newport Corporation. An output side of the OM1 fiber was connected to a 2 m-long OM1 fiber (test reference cord MRC-625-EFC-SCFC manufactured by Fluke Networks, Inc.) with a mode filter, and each POF to be measured was connected to an output side of the OM1 fiber.

The core diameter and the numerical aperture (NA) of incident light incident on the POF to be measured were respectively 57.3 μm and 0.26, which were confirmed to be greater than the core diameter and the numerical aperture (NA) of the POF to be measured. In other words, overfill light was allowed to be incident on the POF to measure the band of the POF.

A universal streak camera C10910 series manufactured by Hamamatsu Photonics K.K. was used as the light receiver. A pulse waveform was obtained with this light receiver.

Measurement for a distance of 5 m was performed in the following manner. First, a 7 m-long POF was prepared. An optical pulse was allowed to be incident on one end portion of the POF, and an optical pulse of output light was measured at a distance of 7 m. After that, the POF was cut to a length of 2 m. In the same manner, an optical pulse was allowed to be incident thereon and an output pulse was measured. For the two output pulses, a transfer function was determined by Fourier transform specified in IEC 60793-1-41, and a frequency at an optical power of −3 dB was determined. Table 1 shows the results. Table 1 shows both the band measurement result (unit: GHZ) obtained by the measurement for a distance of 5 m and that converted to the unit “MHz·km”.

Measurement for a distance of 20 m was performed in the following manner. First, a 22 m-long POF was prepared. An optical pulse was allowed to be incident on one end portion of the POF, and an optical pulse of output light was measured at a distance of 22 m. After that, the POF was cut to a length of 2 m. In the same manner, an optical pulse was allowed to be incident thereon and an output pulse was measured. For the two output pulses, a transfer function was determined by Fourier transform specified in IEC 60793-1-41, and a frequency at an optical power of −3 dB was determined. Table 1 shows the results. Table 1 shows both the band measurement result (unit: GHz) obtained by the measurement for a distance of 20 m and that converted to the unit “MHz·km”.

### [Evaluation of Band and Heat Resistance (Examples 2-1 to 2-8 and Comparative Examples 1 to 3)]

Bands of the POFs of Examples 2-1 to 2-8 and Comparative Examples 1 to 3 were measured for a distance of 5 m by a pulse method which is one of the methods according to IEC 60793-1-41. To measure the bands of the POFs for such a very short distance, an apparatus capable of oscillating ultra-high-speed pulses was used as an optical pulse generator and an apparatus capable of recognizing images in a short time was used as a light receiver. Specifically, the bands were measured by the following method. It should be noted that, as the bands, a band as an initial property before a heat resistance test in which each POF was stored at 85° C. for 1000 hours and a band after the heat resistance test were measured. The heat resistance was evaluated from the band after the heat resistance test.

InSight X3+ manufactured by Spectra-Physics, Inc. was used as the optical pulse generator. A laser with a wavelength of 850 nm was oscillated with this optical pulse generator. The oscillated laser was coupled to an OM1 fiber (“M31L01-OM1, 0.275 NA, Graded-Index Patch Cable” manufactured by Thorlabs, Inc.) through a lens, and mode scrambling was performed with FM-1 manufactured by Newport Corporation. An output side of the OM1 fiber was connected to a 2 m-long OM1 fiber (test reference cord MRC-625-EFC-SCFC manufactured by Fluke Networks, Inc.) with a mode filter, and each POF to be measured was connected to an output side of the OM1 fiber.

The core diameter and the numerical aperture (NA) of incident light incident on the POF to be measured were respectively 57.3 μm and 0.26, which were confirmed to be greater than the core diameter and the numerical aperture (NA) of the POF to be measured. In other words, overfill light was allowed to be incident on the POF to measure the band of the POF.

A universal streak camera C10910 series manufactured by Hamamatsu Photonics K.K. was used as the light receiver. A pulse waveform was obtained with this light receiver.

Measurement for a distance of 5 m was performed in the following manner. First, a 7 m-long POF was prepared. An optical pulse was allowed to be incident on one end portion of the POF, and an optical pulse of output light was measured at a distance of 7 m. After that, the POF was cut to a length of 2 m. In the same manner, an optical pulse was allowed to be incident thereon and an output pulse was measured. For the two output pulses, a transfer function was determined by Fourier transform specified in IEC 60793-1-41, and a frequency at an optical power of −1.5 dB and an optical power at a frequency of 4 GHz were determined. Table 2 shows the results. Table 2 shows the frequency (unit: GHz) at an optical power of −1.5 dB and the optical power (unit: dB) at a frequency of 4 GHz as the band measurement results (band values) obtained by the measurement for a distance of 5 m.

### [Evaluation of Bending Loss]

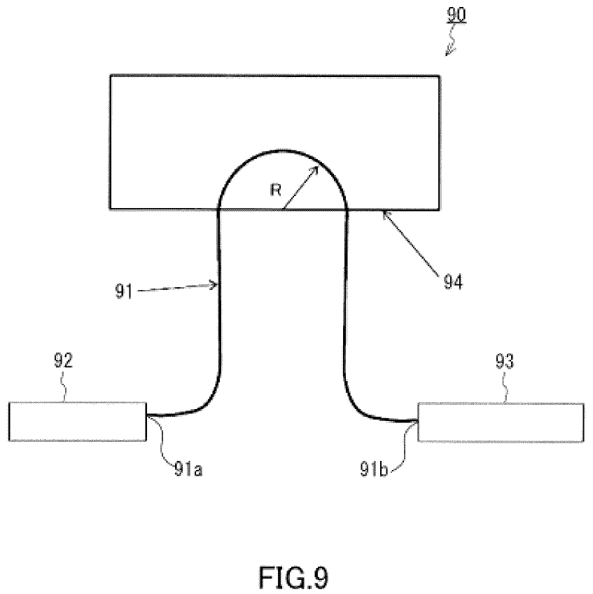

A 5 m-long POF was prepared. FIG. 9 is a schematic diagram showing a measurement system for measuring bending losses of the POFs of Examples and Comparative Examples. In a measurement system 90, FOLS-01 (LED with 850 nm wavelength) manufactured by Craft Center SAWAKI Inc. was connected as a light source 92 to an input side 91a of a POF 91. An optical power meter 8230E manufactured by ADC CORPORATION was connected as an optical power meter 93 to a light receiving side 91b of the POF 90. The POF was wound 10 times around a 12.5 mm-diameter cylinder at a point 1 m from the input side to remove a cladding mode. A central portion (a portion 2.5 m from both sides) of the POF was set in a plate 94, as shown in FIG. 9, with a U-shaped groove having a bending radius R to bend the POF. An amount of change in insertion loss attributable to the change from a straight state to a bending state was confirmed in this manner to determine an optical loss. An optical loss (first optical loss) obtained by bending the POF into a U shape at a bending radius R of 1.5 mm and an optical loss (second optical loss) obtained by bending the POF into a U shape at a bending radius R of 2.5 mm were determined for Examples and Comparative Examples. Tables 1 and 2 show the results.

### [Evaluation of Numerical Aperture (NA)]

The numerical aperture (NA) was measured by a far field pattern (FFP) method, which is one of the methods according to IEC 60793-1-43 and IEC 60793-2-40 subcategory A4h, using light with a wavelength of 850 nm. A 6 m-long POF was prepared, and LED light with a wavelength of 850 nm was allowed to be incident on one end portion of the POF. Measurement for a light intensity distribution at angular positions of output light was performed at a distance of 6 m, and then the numerical aperture (NA) was calculated. Tables 1 and 2 show the results.

TABLE 1

| | | | | | | | | | | Bending loss | | |
|---|---|---|---|---|---|---|---|---|---|---|---|---|
| | | | Refractive | | | | | | | Second | First | |
| | | | index | Thickness | | Band value for | | Band value for | | optical | optical | Numerical |
| | Refractive | Refractive | difference | d (μm) of | | 5 m | | 20 m | | loss | loss | aperture |
| | index n1 | index n2 | Δn | trench | Δn × d | GHz | MHz · km | GHz | MHz · km | (R = 2.5 mm) | (R = 1.5 mm) | (NA) |
| Ex. 1-1 | 1.330 | 1.324 | 0.006 | 3 | 0.018 | 65.1 | 325.5 | 20.6 | 412 | 0.20 | 1.53 | 0.150 |
| Ex. 1-2 | 1.330 | 1.324 | 0.006 | 4 | 0.024 | 75.7 | 378.5 | 28.1 | 562 | 0.15 | 1.31 | 0.167 |
| Ex. 1-3 | 1.330 | 1.324 | 0.006 | 5 | 0.03 | 67.0 | 335 | 37.8 | 756 | 0.1 | 0.86 | 0.185 |
| Ex. 1-4 | 1.330 | 1.324 | 0.006 | 6.5 | 0.039 | 10.2 | 51 | 3.4 | 68 | 0.09 | 0.86 | 0.229 |
| Ex. 1-5 | 1.330 | 1.324 | 0.006 | 8 | 0.048 | 11.3 | 56.5 | 3.4 | 68 | 0.08 | 0.78 | 0.235 |
| Ex. 1-6 | 1.330 | 1.321 | 0.009 | 2 | 0.0188 | 71.0 | 355 | 18.0 | 360 | 0.25 | 1.40 | 0.15 |
| Comp. | 1.330 | — | 0 | 0 | 0 | 39.3 | 196.5 | 13.2 | 264 | 2.78 | 6.97 | 0.149 |
| Ex. 1 | | | | | | | | | | | | |
| Comp. | 1.338 | — | 0 | 0 | 0 | 39.1 | 195.5 | 15.6 | 312 | 2.07 | 5.45 | 0.185 |
| Ex. 2 | | | | | | | | | | | | |
| Comp. | 1.338 | 1.325 | 0.013 | 5 | 0.065 | 2.8 | 14 | 1.3 | 26 | 0.13 | 0.85 | 0.245 |
| Ex. 3 | | | | | | | | | | | | |

TABLE 2

| | | | | | | | Band | | Band (after heat | |
|---|---|---|---|---|---|---|---|---|---|---|
| | | | | | | | (initial property) | | resistance test) | |
| | | | | Bending loss | | | Frequency | Optical | Frequency | Optical |
| | | Refractive | | First | Second | | (GHz) at | power | (GHz) at | power |
| | Thickness | index | | optical | optical | Numerical | optical | (dB) at | optical | (dB) at |
| | d (μm) of | difference | | loss | loss | aperture | power of | frequency | power of | frequency |
| | trench | Δn | Δn × d | (R = 1.5 mm) | (R = 2.5 mm) | (NA) | −1.5 dB | of 4 GHz | −1.5 dB | of 4 GHz |
| Ex. 2-1 | 2.1 | 0.006 | 0.013 | 1.54 | 0.42 | 0.13 | 83.0 | 0 | 71.5 | 0 |
| Ex. 2-2 | 3.0 | 0.006 | 0.018 | 1.53 | 0.20 | 0.16 | 67.6 | 0 | 67.0 | 0 |
| Ex. 2-3 | 3.7 | 0.006 | 0.022 | 1.46 | 0.17 | 0.16 | 51.6 | 0 | 61.1 | −0.033 |
| Ex. 2-4 | 3.8 | 0.006 | 0.023 | 1.40 | 0.17 | 0.16 | 53.9 | 0 | 47.4 | 0 |
| Ex. 2-5 | 3.9 | 0.006 | 0.023 | 1.31 | 0.16 | 0.17 | 71.8 | 0 | 73.1 | 0 |
| Ex. 2-6 | 4.4 | 0.006 | 0.026 | 1.41 | 0.17 | 0.17 | 80.2 | 0 | 89.6 | −0.467 |
| Ex. 2-7 | 5 | 0.006 | 0.030 | 0.86 | 0.15 | 0.19 | 102.3 | 0 | 95.5 | −0.650 |
| Ex. 2-8 | 8 | 0.006 | 0.048 | 0.78 | 0.08 | 0.16 | 68.7 | 0 | 68.7 | −1.024 |
| Comp. | 0 | 0 | 0.000 | 6.97 | 2.78 | 0.15 | 39.3 | −0.044 | — | — |
| Ex. 1 | | | | | | | | | | |
| Comp. | 0 | 0 | 0.000 | 5.45 | 2.07 | 0.19 | 39.1 | −0.269 | — | — |
| Ex. 2 | | | | | | | | | | |
| Comp. | 5 | 0.013 | 0.065 | 0.85 | 0.13 | 0.25 | 2.8 | −1.308 | — | — |
| Ex. 3 | | | | | | | | | | |

As shown in Table 1, the POFs of Examples 1-1 to 1-6 for which the value of Δn×d was 0.010 or more and 0.06 or less were able to reduce the bending loss and achieve a high band. On the other hand, the POFs of Comparative Examples 1 and 2 provided with no trench had a large bending loss although having a relatively high band. Moreover, the POF of Comparative Example 3 that was provided with a trench but for which the value of Δn×d was more than 0.06 had a low band value although having a small bending loss.

As shown in Table 2, the POFs of Examples 2-1 to 2-8 for which the value of Δn×d was 0.010 or more and 0.06 or less were able to reduce the bending loss and achieve a high band. Furthermore, the POFs of Examples 2-1 to 2-6 for which the value of Δn×d was less than 0.030 and that includes a trench having a thickness of less than 5 μm had a reduced bending loss, achieved a high band, and showed excellent heat resistance, which was demonstrated by reduced degradation of the band, even after the heat resistance test. Specifically, for the POFs of Examples 2-1 to 2-6, the bands were not greatly degraded after the heat resistance test, and the optical power after the heat resistance test was more than −0.650 dB at a frequency of 4 GHz; the POFs of Examples 2-1 to 2-6 had excellent heat resistance. On the other hand, for the POFs of Examples 2-7 and 2-8, the optical power after the heat resistance test was-0.650 dB or less at a frequency of 4 GHz; the POFs of Examples 2-7 and 2-8 had insufficient heat resistance compared to the POFs of Examples 2-1 to 2-6. In Table 2, “-” indicates that the measurement was not performed for the following reasons. For the POFs of Comparative Examples 1 and 2, the measurement of the band after the heat resistance test was not performed because the bending loss was large. The POF of Comparative Example 3 that was provided with a trench but for which the value of Δn×d was as large as 0.065 had a low band value although having a small bending loss. For the POF of Comparative Example 3, the band after the heat resistance test was not measured because the initial band value was low.

### [Supplement]

In summary, the invention of the present disclosure has the following aspects.

(1)

A plastic optical fiber including:
a core including a first region having a refractive index decreasing in a direction from a center of the core toward an outer edge of the core; and
a trench disposed on an outer circumference of the core, wherein
when a refractive index difference between a refractive index n1 at the outer edge of the core and a refractive index n2 of the trench is defined as Δn and a thickness of the trench is defined as d (μm), a value of Δn×d is 0.010 or more and 0.06 or less.
   (2)

The plastic optical fiber according to (1), wherein the value of Δn×d is 0.015 or more and 0.06 or less.

(3)

The plastic optical fiber according to (2), wherein the value of Δn×d is 0.02 or more and 0.06 or less.

(4)

The plastic optical fiber according to (3), wherein the value of Δn×d is 0.035 or more and 0.06 or less.

(5)

The plastic optical fiber according to (2) or (3), wherein the thickness d (μm) of the trench is 2 μm or more and 10 μm or less.

(6)

The plastic optical fiber according to (1), wherein the value of Δn×d is 0.010 or more and less than 0.03.

(7)

The plastic optical fiber according to (6), wherein the value of Δn×d is 0.012 or more and less than 0.030.

(8)

The plastic optical fiber according to (7), wherein the value of Δn×d is 0.012 or more and 0.026 or less.

(9)

The plastic optical fiber according to any one of (6) to (8), wherein the thickness d (μm) of the trench is 2 μm or more and 5 μm or less.

(10)

The plastic optical fiber according to any one of (6) to (9), wherein when optical power is used to evaluate a band value of the plastic optical fiber having been held at 85° C. for 1000 hours, the optical power is more than −0.65 dB at a frequency of 4 GHZ.

(11)

The plastic optical fiber according to any one of (1) to (10), wherein a first optical loss of the plastic optical fiber bent into a U shape at a bending radius of 1.5 mm is 3.0 dB or less.

(12)

The plastic optical fiber according to (11), wherein the first optical loss is 2.0 dB or less.

(13) The plastic optical fiber according to any one of (1) to (12), wherein a second optical loss of the plastic optical fiber bent into a U shape at a bending radius of 2.5 mm is 1.0 dB or less.
(14)

The plastic optical fiber according to any one of (1) to (13), wherein a numerical aperture (NA) of the plastic optical fiber is 0.15 or more and 0.24 or less.

(15)

The plastic optical fiber according to any one of (1) to (14), wherein the refractive index n2 of the trench is 1.32 or more and 1.34 or less at a wavelength of 850 nm.

(16)

The plastic optical fiber according to any one of (1) to (15), wherein the core further includes a second region including the outer edge and having a refractive index being constant at the refractive index n1.

(17)

A plastic optical fiber including:
a core including a first region having a refractive index decreasing in a direction from a center of the core toward an outer edge of the core; and
a trench disposed on an outer circumference of the core, wherein
a refractive index n2 of the trench is lower than a refractive index n1 at the outer edge of the core, and
a thickness d (μm) of the trench is 2 μm or more and less than 5 μm.
   (18)

The plastic optical fiber according to (17), wherein the thickness d (μm) of the trench is 2 μm or more and 4.5 μm or less.

(19)

An optical cord including the plastic optical fiber according to any one of (1) to (18).

(20)

An active optical cable including:
the optical cord according to (19); and
an optoelectronic hybrid module.

### INDUSTRIAL APPLICABILITY

The POF of the present disclosure can reduce a bending loss and achieve an improved band in a short distance. Therefore, the POF of the present disclosure is suitable for applications such as signal transmission in a short distance, for example, in home.

What is claimed is:

1. A plastic optical fiber comprising:
a core including a first region having a refractive index decreasing in a direction from a center of the core toward an outer edge of the core; and
a trench disposed on an outer circumference of the core, wherein
when a refractive index difference between a refractive index n1 at the outer edge of the core and a refractive index n2 of the trench is defined as Δn and a thickness of the trench is defined as d (μm), a value of Δn×d is 0.010 or more and 0.06 or less.

2. The plastic optical fiber according to claim 1, wherein the value of Δn×d is 0.015 or more and 0.06 or less.

3. The plastic optical fiber according to claim 2, wherein the value of Δn×d is 0.02 or more and 0.06 or less.

4. The plastic optical fiber according to claim 3, wherein the value of Δn×d is 0.035 or more and 0.06 or less.

5. The plastic optical fiber according to claim 2, wherein the thickness d (μm) of the trench is 2 μm or more and 10 μm or less.

6. The plastic optical fiber according to claim 1, wherein the value of Δn×d is 0.010 or more and less than 0.03.

7. The plastic optical fiber according to claim 6, wherein the value of Δn×d is 0.012 or more and less than 0.030.

8. The plastic optical fiber according to claim 7, wherein the value of Δn×d is 0.012 or more and 0.026 or less.

9. The plastic optical fiber according to claim 6, wherein the thickness d (μm) of the trench is 2 μm or more and 5 μm or less.

10. The plastic optical fiber according to claim 6, wherein when optical power is used to evaluate a band value of the plastic optical fiber having been held at 85° C. for 1000 hours, the optical power is more than −0.65 dB at a frequency of 4 GHZ.

11. The plastic optical fiber according to claim 1, wherein a first optical loss of the plastic optical fiber bent into a U shape at a bending radius of 1.5 mm is 3.0 dB or less.

12. The plastic optical fiber according to claim 11, wherein the first optical loss is 2.0 dB or less.

13. The plastic optical fiber according to claim 1, wherein a second optical loss of the plastic optical fiber bent into a U shape at a bending radius of 2.5 mm is 1.0 dB or less.

14. The plastic optical fiber according to claim 1, wherein a numerical aperture (NA) of the plastic optical fiber is 0.15 or more and 0.24 or less.

15. The plastic optical fiber according to claim 1, wherein the refractive index n2 of the trench is 1.32 or more and 1.34 or less at a wavelength of 850 nm.

16. The plastic optical fiber according to claim 1, wherein the core further includes a second region including the outer edge and having a refractive index being constant at the refractive index n1.

17. A plastic optical fiber comprising:
a core including a first region having a refractive index decreasing in a direction from a center of the core toward an outer edge of the core; and
a trench disposed on an outer circumference of the core, wherein
a refractive index n2 of the trench is lower than a refractive index n1 at the outer edge of the core, and
a thickness d (μm) of the trench is 2 μm or more and less than 5 μm.

18. The plastic optical fiber according to claim 17, wherein the thickness d (μm) of the trench is 2 μm or more and 4.5 μm or less.

19. An optical cord comprising the plastic optical fiber according to claim 1.

20. An active optical cable comprising:
the optical cord according to claim 19; and
an optoelectronic hybrid module.
